(19) United States
(12) Patent Application Publication
(10) Pub. No.: US 2026/0051826 A1
(43) Pub. Date: Feb. 19, 2026

(54) POWER SUPPLY DEVICE

(71) Applicant: Chicony Power Technology Co., Ltd., New Taipei City (TW)

(72) Inventors: Sheng-Jie Peng, New Taipei City (TW); Chih-Hsiang Chung, New Taipei City (TW)

(73) Assignee: Chicony Power Technology Co., Ltd., New Taipei City (TW)

(21) Appl. No.: 18/928,417

(22) Filed: Oct. 28, 2024

(30) Foreign Application Priority Data
Aug. 16, 2024 (TW) 113131007

(51) Int. Cl. H02M 7/12; H01C 10/10; H02H 9/02; H02M 1/00; H02M 7/219

(52) U.S. Cl. CPC H02M 7/125; H01C 10/103; H02H 9/02; H02M 1/0009; H02M 7/219

(57) ABSTRACT

A power supply device includes an input port, an active-rectifier circuit, a surge-discharge circuit, a detection circuit, a rectification-control circuit, a protection-control circuit, and a drive circuit. The surge-discharge circuit is coupled between the input port and the active-rectifier circuit. The detection circuit outputs an output signal, normally a regular signal, to the protection-control circuit and, in response to detecting a surge signal from the surge-discharge circuit, changes the output signal to an activation signal. The protection-control circuit, in response to receiving the regular signal, outputs the control signal as an operation signal. The drive circuit then outputs a drive signal to the active-rectifier circuit according to the operation signal. The protection-control circuit, in response to receiving an activation signal, temporarily interrupts outputting the control signal as the operation signal. The drive circuit then stops outputting the drive signal.

### CROSS-REFERENCE TO RELATED APPLICATION

This non-provisional application claims priority under 35 U.S.C. § 119 (a) to patent application No. 113131007 filed in Taiwan, R.O.C. on Aug. 16, 2024, the entire contents of which are hereby incorporated by reference.

### BACKGROUND

### Technical Field

The present disclosure relates to a power supply device, and particularly relates to a power supply device capable of executing protection immediately when a surge occurs.

### Related Art

Currently, active-rectifier circuits have active switches to achieve diode rectification. However, when a surge occurs, if the switch continues to run and is turned on, the surge energy may pass through the switch, causing damage to the switch. Therefore, an existing method is to turn off the switch for a safety time period when a surge occurs, and then wait the safety time period before the switch resumes running. However, the waiting method of maintaining a fixed safety time has the problem that the waiting time is too long and it is impossible to truly confirm whether the surge has disappeared, affecting the overall efficiency.

### SUMMARY

One embodiment of the present disclosure provides a power supply device, including an input port, an active-rectifier circuit, a surge-discharge circuit, a detection circuit, a rectification-control circuit, a protection-control circuit and a drive circuit. The input port receives a power supply signal. The active-rectifier circuit is coupled to the input port. The surge-discharge circuit is coupled between the input port and the active-rectifier circuit. The detection circuit includes a detection end and an output end. The detection end is coupled to the surge-discharge circuit. The output end outputs an output signal, normally a regular signal. In response to detecting a surge signal from the surge-discharge circuit at the detection end, the output signal is changed from the regular signal to an activation signal. The rectification-control circuit outputs a control signal. The protection-control circuit is coupled to the output end of the detection circuit and the rectification-control circuit to receive the output signal and the control signal and output an operation signal. In response to the output signal being the regular signal, the protection-control circuit outputs the control signal as the operation signal, and in response to the output signal being the activation signal, the protection-control circuit temporarily interrupts outputting the control signal as the operation signal. The drive circuit is coupled between the protection-control circuit and the active-rectifier circuit to output a drive signal to the active-rectifier circuit according to the operation signal when the operation signal being the control signal is received, and stop outputting the drive signal when the operation signal being the control signal is not received.

According to the power supply device provided by some embodiments of the present disclosure, a switch of the active-rectifier circuit can be turned off immediately when a surge occurs, thereby achieving an effect of protecting the switch, and the active-rectifier circuit resumes running immediately after the surge disappears.

### BRIEF DESCRIPTION OF THE DRAWINGS

FIG. 1 is a circuit diagram of a power supply device according to one embodiment of the present disclosure.

FIG. 2 is a circuit diagram of a power supply device according to one embodiment of the present disclosure.

FIG. 3 is a detail circuit diagram of a power supply device according to one embodiment of the present disclosure.

FIG. 4 is a waveform diagram of a first drive signal, a second drive signal and a surge according to one embodiment of the present disclosure.

FIG. 5 is a local amplification diagram of a frame K in FIG. 4.

FIG. 6 is a detail circuit diagram of a power supply device according to another embodiment of the present disclosure.

### DETAILED DESCRIPTION

“Coupling” used herein refers to mutually “direct” physical contact or electrical contact of two or more elements, or mutually “indirect” physical contact or electrical contact of the two or more elements, or mutual action of the two or more elements.

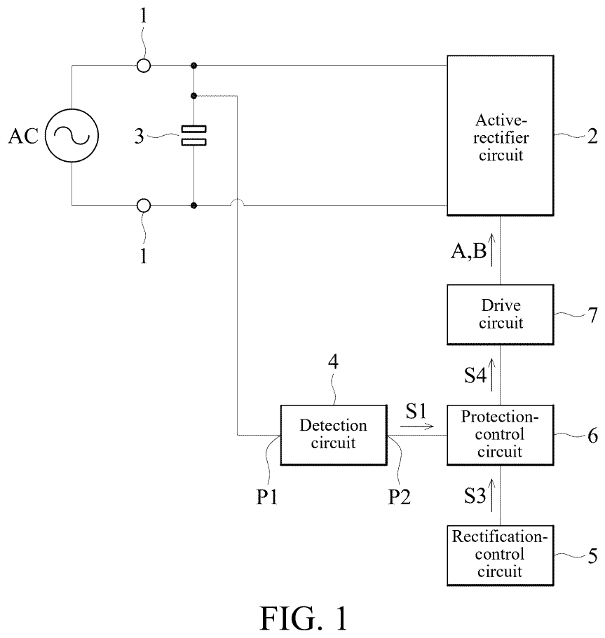

FIG. 1 is a circuit diagram of a power supply device according to one embodiment of the present disclosure. The power supply device includes an input port 1, an active-rectifier circuit 2, a surge-discharge circuit 3, a detection circuit 4, a rectification-control circuit 5, a protection-control circuit 6 and a drive circuit 7. The input port 1 is provided with two input ends respectively coupled to two ends of a power supply AC to receive a power supply signal supplied by the power supply AC. The active-rectifier circuit 2 is coupled to the input port 1 to rectify the power supply signal. The surge-discharge circuit 3 is coupled between the input port 1 and the active-rectifier circuit 2 to guide a surge signal out when a surge occurs, so as to prevent the surge signal from flowing into the active-rectifier circuit 2. In some embodiments, the surge-discharge circuit 3 includes a piezoresistor normally in a high-resistance state just like an open circuit; and when a surge occurs, the resistance of the piezoresistor rapidly reduces, and thus the piezoresistor becomes a conductor to guide the surge signal out.

The detection circuit 4 includes a detection end P1 and an output end P2. The detection end P1 is coupled to the surge-discharge circuit 3 to detect whether the surge-discharge circuit 3 outputs the surge signal or not. The output end P2 generates an output signal S1 according to the detection result. Normally, the output signal S1 is in a first state (the output signal S1 in the first state is called as a “regular signal”). In response to detecting the surge signal at the detection end P1, the output signal S1 is changed to a second state from the first state (the output signal S1 in the second state is called as an “activation signal”). In other words, the output end P2 normally outputs the regular signal; and when the surge signal is detected, the output end P2 outputs an activation signal.

The rectification-control circuit 5 outputs a control signal S3. The protection-control circuit 6 is coupled to the output end P2 of the detection circuit 4 and the rectification-control circuit 5 to respectively receive the output signal S1 and the control signal S3. The protection-control circuit 6 outputs an operation signal S4. In response to receiving the output signal S1 being the regular signal, the protection-control circuit 6 outputs the control signal S3 as the operation signal S4. The outputted operation signal S4 is equivalent to the control signal S3. In response to receiving the output signal S1 being the activation signal, the protection-control circuit 6 temporarily interrupts outputting the control signal S3 as the operation signal S4. The output operation signal S4 does not change along with the control signal S3.

The drive circuit 7 is coupled between the protection-control circuit 6 and the active-rectifier circuit 2 to receive the operation signal S4 from the protection-control circuit 6, and accordingly generate a drive signal (such as in a proper operation voltage and current range) suitable for controlling an internal switch of the active-rectifier circuit 2, so as to control the switch action of the active-rectifier circuit 2. When the protection-control circuit 6 outputs the operation signal S4 equivalent to the control signal S3, the drive circuit 7 outputs the drive signal (including a first drive signal A and a second drive signal B) to the active-rectifier circuit 2 according to the operation signal S4. Moreover, when the protection-control circuit 6 interrupts outputting the control signal S3 as the operation signal S4 (namely, when the drive circuit 7 does not receive the operation signal S4 being the control signal S3), the drive circuit 7 correspondingly stops outputting the drive signal. The mode of outputting the drive signal according to the operation signal S4 can be that, for example, the first drive signal A with a corresponding time sequence is generated according to the operation signal S4 (equivalent to the control signal S3), and then the first drive signal A is inverted into the second drive signal B, but no limitation is made to the present disclosure.

By way of the above embodiment, when a surge occurs, the switch of the active-rectifier circuit 2 turns off instantly because it is not controlled by the drive signal, thereby preventing the switch from being impacted by the surge energy. In addition, after the surge disappears, the switch of the active-rectifier circuit 2 is immediately controlled by the drive signal and resumes running.

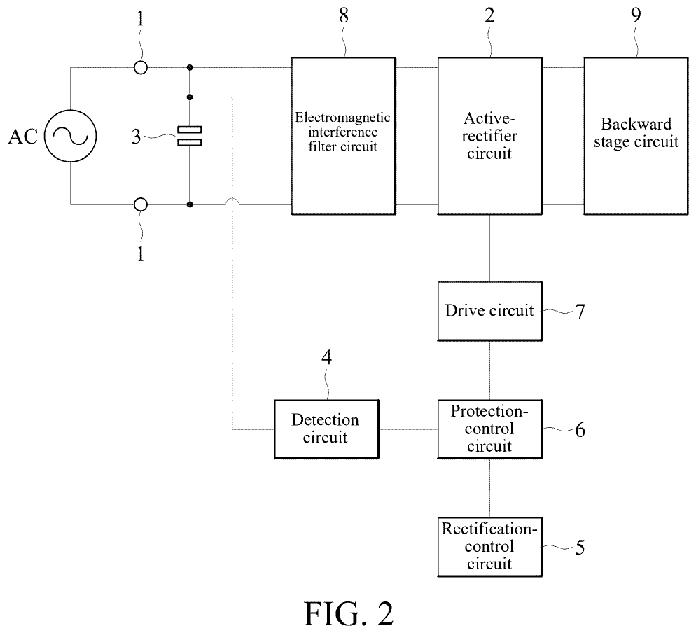

FIG. 2 is a circuit diagram of a power supply device according to one embodiment of the present disclosure. The difference from FIG. 1 is that in some embodiments, the power supply device further includes an electromagnetic interference filter circuit 8 and a backward stage circuit 9. The electromagnetic interference filter circuit 8 is coupled between the surge-discharge circuit 3 and the active-rectifier circuit 2. In some embodiments, the electromagnetic interference filter circuit 8 includes a filter (such as an LC filter or a common mode choke) to restrain electromagnetic interference (EMI). The backward stage circuit 9 is coupled to the active-rectifier circuit 2 to receive the output of the active-rectifier circuit 2. The backward stage circuit 9 can be a load or voltage regulation circuit (such as a DC-DC converter).

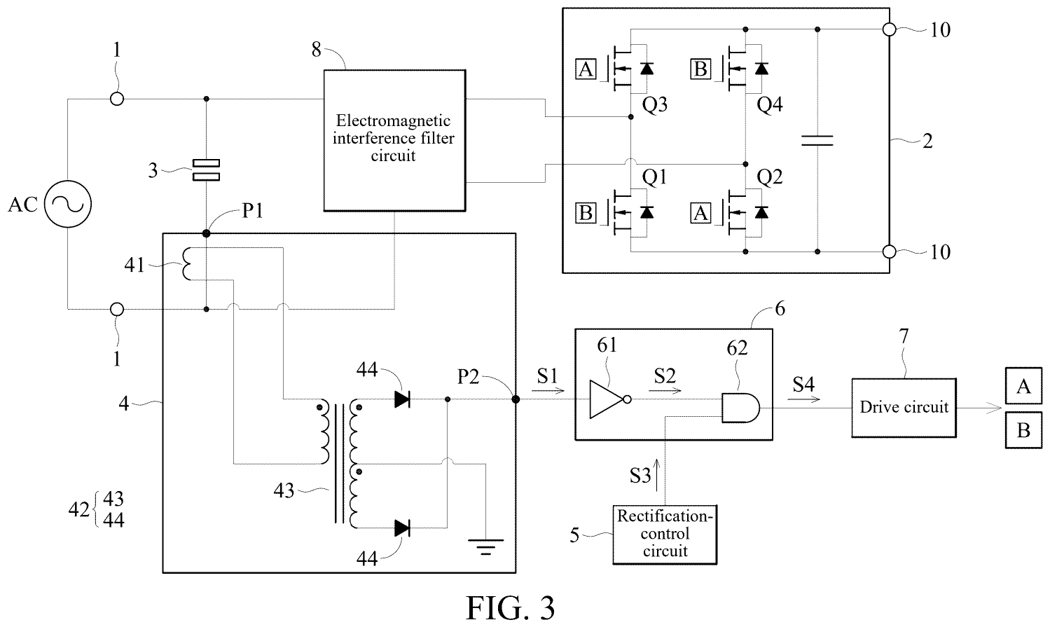

FIG. 3 is a detail circuit diagram of a power supply device according to one embodiment of the present disclosure. In some embodiments, the detection circuit 4 includes a current sensing circuit 41 and a proportional rectifier circuit 42. The current sensing circuit 41 is positioned at the detection end P1 to convert the surge signal into a sensing voltage. In some embodiments, the current sensing circuit 41 is a current transformer (CT) and is arranged on a path with the surge-discharge circuit 3 to sense the current of the surge signal when the surge signal is generated and generate the sensing voltage capable of representing the current magnitude. The proportional rectifier circuit 42 is coupled to the current sensing circuit 41 and is positioned at the output end P2 to receive the sensing voltage, reduce the sensing voltage by a down-regulation ratio and rectify the sensing voltage into the output signal S1.

As shown in FIG. 3, in some embodiments, the proportional rectifier circuit 42 includes a transformer 43 and two diodes 44. The transformer 43 includes a primary coil and a secondary coil. Two ends of the primary coil are correspondingly coupled to two ends of the current sensing circuit 41 to receive the sensing voltage. Two ends of the secondary coil are correspondingly coupled to anodes of the diodes 44, and cathodes of the two diodes 44 are coupled to each other and are coupled to the output end P2. A central tap of the secondary coil of the transformer 43 is grounded. A full-wave-rectifier circuit is formed through the proportional rectifier circuit 42 with the above structure to reduce the sensing voltage by the down-regulation ratio and rectify the sensing voltage. The surge signal in an AC form is converted into a DC signal and reduced to a proper voltage range to avoid damaging subsequent electronic elements. The down-regulation ratio corresponds to the turn ratio of the transformer 43.

As shown in FIG. 3, in some embodiments, the active-rectifier circuit 2 is a full-bridge rectifier circuit and includes switches Q1-Q4 and an output port 10. The output port 10 is coupled to the backward stage circuit 9 (as shown in FIG. 2). Anodes of body diodes of the switches Q1 and Q2 are coupled to each other and are coupled to an output end of the output port 10. A cathode of the body diode of the switch Q1 is coupled to the anode of the body diode of the switch Q3, and is coupled to the electromagnetic interference filter circuit 8, or is coupled to an input end (in case of no electromagnetic interference filter circuit 8) of the input port 1. A cathode of the body diode of the switch Q2 is coupled to the anode of the body diode of the switch Q4, and is coupled to the electromagnetic interference filter circuit 8, or is coupled to the other input end (in case of no electromagnetic interference filter circuit 8) of the input port 1. Cathodes of the body diodes of the switches Q3 and Q4 are coupled to each other and are coupled to the other output end of the output port 10. The switches Q1-Q4 are divided into two switch groups, and the two switch groups are respectively turned on in different half cycles of AC. Here, the switches Q2 and Q3 are treated as a first switch group, and the switches Q1 and Q4 are treated as a second switch group. The first switch group receives the first drive signal A, and correspondingly changes between a turn-on state and a turn-off state according to the time sequence change in the first drive signal A. The second switch group receives the second drive signal B, and correspondingly changes between a turn-on state and a turn-off state according to the time sequence change in the second drive signal B.

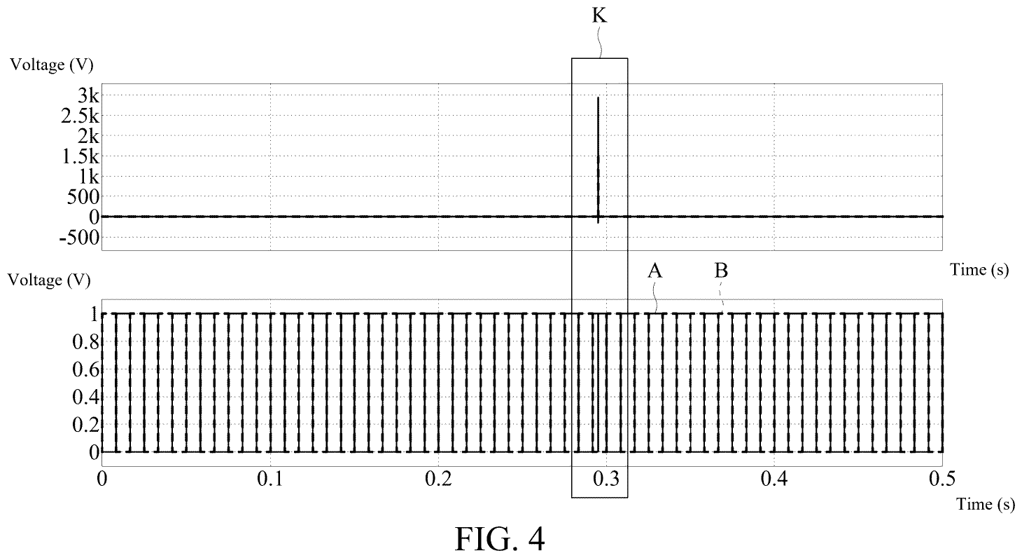

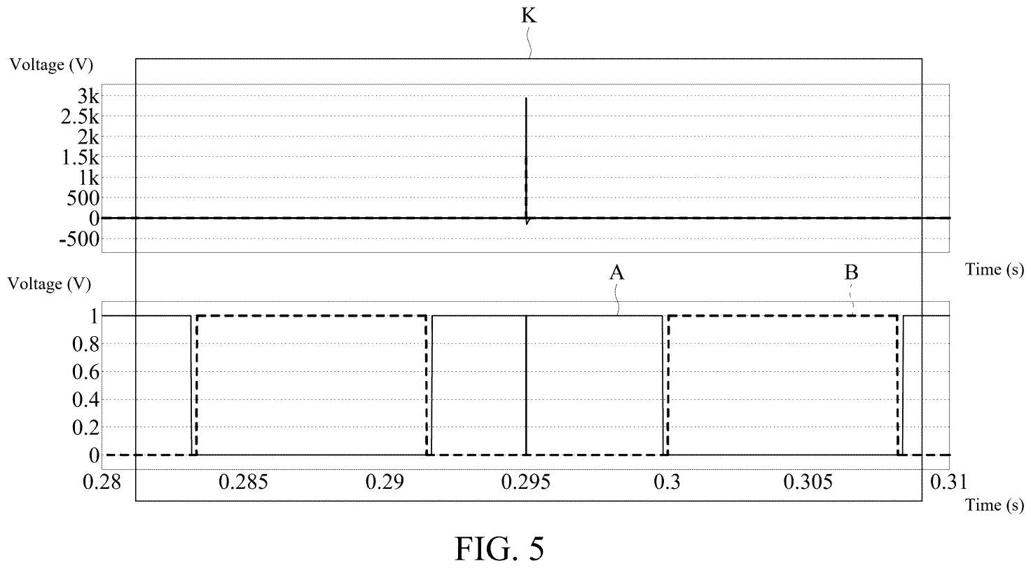

As shown in FIG. 4 and FIG. 5, FIG. 4 is a waveform diagram of a first drive signal A, a second drive signal B and a surge according to one embodiment of the present disclosure. FIG. 5 is a local amplification diagram of a frame K in FIG. 4. Waveform diagrams of the first drive signal A and the second drive signal B are at the lower parts of FIG. 4 and FIG. 5, and waveform diagrams of the surge are at the upper parts of FIG. 4 and FIG. 5. The first drive signal A and the second drive signal B are complementary. That is, when the first drive signal A is at a low potential, the second drive signal B is at a high potential; and when the first drive signal A is at the high potential, the second drive signal B is at the low potential. When a surge occurs (at about 0.295 s), the protection-control circuit 6 interrupts outputting the control signal S3 as the operation signal S4. The drive circuit 7 stops outputting the first drive signal A and the second drive signal B, the first drive signal A originally at the high potential is changed to the low potential, and the second drive signal B originally at the low potential is kept at the low potential, thereby turning off the switches Q1-Q4.

As shown in FIG. 3, normally, a path on the surge-discharge circuit 3 is an open circuit. Thus, the detection circuit 4 cannot detect current, and the output signal S1 is a low-potential regular signal. On the contrary, when a surge signal occurs, the detection circuit 4 detects current, and thus the output signal S1 is a high-potential activation signal. In some embodiments, the protection-control circuit 6 includes a NOT gate 61 and an AND gate 62. The NOT gate 61 is coupled to the output end P2 of the detection circuit 4 to invert the output signal S1 into an inverted signal S2. When the output signal S1 is a low-potential regular signal, the NOT gate 61 converts the regular signal into a high-potential signal to be outputted as the inverted signal S2. On the other hand, when the output signal S1 is the high-potential activation signal, the NOT gate 61 converts the activation signal into the low-potential signal to be outputted as the inverted signal S2. Two input ends of the AND gate 62 are coupled to the NOT gate 61 and the rectification-control circuit 5 respectively to receive the inverted signal S2 and the control signal S3 respectively, and execute AND logic operation on the two signals to output the operation signal S4. In other words, the AND gate 62 determines whether to output the control signal S3 as the operation signal S4 through the inverted signal S2. In response to the received inverted signal S2 at a high potential, the AND gate 62 outputs the control signal S3 as the operation signal S4. In response to the received inverted signal S2 at a low potential, and the output of the AND gate 62 is the low-potential operation signal S4, outputting the control signal S3 as the operation signal S4 is temporarily interrupted.

As shown in FIG. 3, the drive circuit 7 is coupled to the output end of the AND gate 62 to receive the operation signal S4. The drive circuit 7 generates a drive signal (including a first drive signal A and a second drive signal B) according to the operation signal S4. Therefore, when the operation signal S4 equivalent to the control signal S3 is received, the drive circuit 7 correspondingly outputs the first drive signal A to the first switch group, and outputs the second drive signal B to the second switch group. When the operation signal S4 being the control signal S3 is not received (the operation signal S4 is at a low potential), the drive circuit 7 stops outputting the first drive signal A and the second drive signal B (kept at a low potential). The switches Q1-Q4 are turned off.

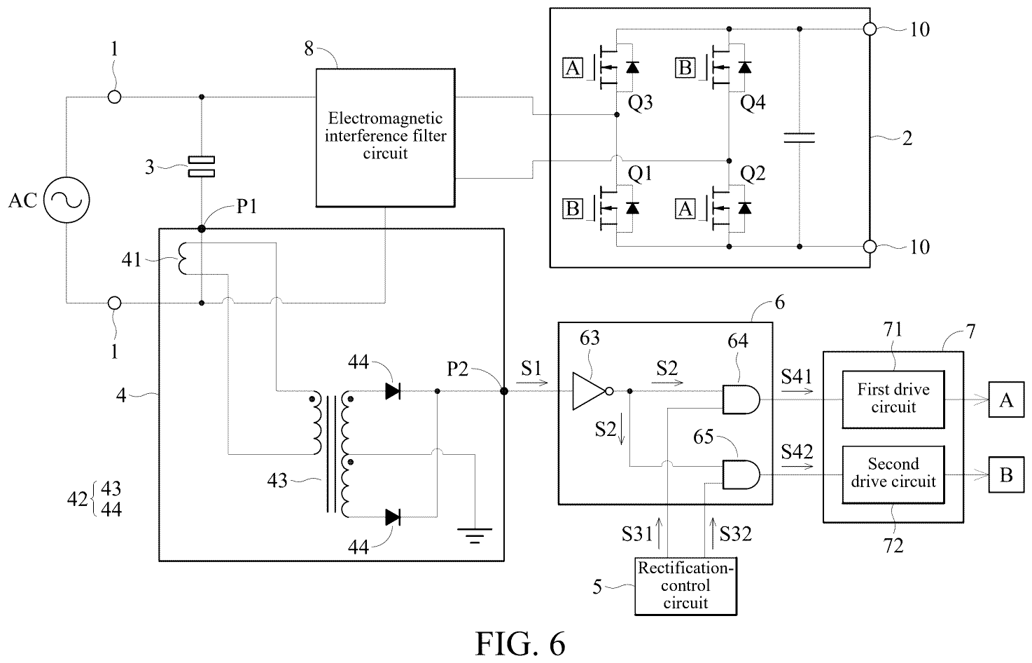

FIG. 6 is a detail circuit diagram of a power supply device according to another embodiment of the present disclosure. The main difference from FIG. 3 is that the internal structures of the protection-control circuit 6 and the drive circuit 7 and the control signal outputted by the rectification-control circuit 5 in FIG. 6 are different, and the following describes the difference only. The control signal S3 outputted by the rectification-control circuit 5 includes a first control signal S31 and a second control signal S32. The second control signal S32 and the first control signal S31 are complementary. That is, when the first control signal S31 is at the low potential, the second control signal S32 is at the high potential; and when the first control signal S31 is at the high potential, the second control signal S32 is at the low potential.

The protection-control circuit 6 includes a NOT gate 63, a first AND gate 64 and a second AND gate 65. The NOT gate 63 is coupled to the output end P2 of the detection circuit 4 to invert the output signal S1 into an inverted signal S2. When the output signal S1 is the low-potential regular signal, the NOT gate 63 converts the regular signal into the high-potential signal to be outputted as the inverted signal S2. On the other hand, when the output signal S1 is the high-potential activation signal, the NOT gate 63 converts the activation signal into the low-potential signal to be outputted as the inverted signal S2.

Two input ends of the first AND gate 64 are respectively coupled to the NOT gate 63 and the rectification-control circuit 5 to respectively receive the inverted signal S2 and the first control signal S31, and execute AND logic operation on the two signals to output a first operation signal S41. In other words, the first AND gate 64 determines whether to output the first control signal S31 as the first operation signal S41 through the inverted signal S2. In response to the received inverted signal S2 at the high potential, the first AND gate 64 outputs the first control signal S31 as the first operation signal S41. In response to the received inverted signal S2 at the low potential, and the first operation signal S41 outputted by the first AND gate 64 is at the low potential, outputting the first control signal S31 as the first operation signal S41 is temporarily interrupted.

Two input ends of the second AND gate 65 are respectively coupled to the NOT gate 63 and the rectification-control circuit 5 to respectively receive the inverted signal S2 and the second control signal S32, and execute AND logic operation on the two signals to output a second operation signal S42. In other words, the second AND gate 65 determines whether to output the second control signal S32 as the second operation signal S42 through the inverted signal S2. In response to the received inverted signal S2 at the high potential, the second AND gate 65 outputs the second control signal S32 as the second operation signal S42. In response to the received inverted signal S2 at the low potential, and the second operation signal S42 outputted by the second AND gate 65 is at the low potential, outputting the second control signal S32 as the second operation signal S42 is temporarily interrupted. In the embodiment, the first operation signal S41 and the second operation signal S42 form the operation signal S4.

The drive circuit 7 includes a first drive circuit 71 and a second drive circuit 72. The first drive circuit 71 is coupled to the output end of the first AND gate 64 to receive the first operation signal S41. The first drive circuit 71 generates the first drive signal A according to the first operation signal S41. Therefore, when the first operation signal S41 equivalent to the first control signal S31 is received, the first drive circuit 71 correspondingly outputs the first drive signal A to the first switch group. The first switch group correspondingly changes between a turn-on state and a turn-off state according to the time sequence change in the first drive signal A. When the first operation signal S41 equivalent to the first control signal S31 is not received (the first operation signal S41 is at the low potential), the first drive circuit 71 stops outputting the first drive signal A (kept at the low potential). The switches Q2 and Q3 are turned off.

The second drive circuit 72 is coupled to the output end of the second AND gate 65 to receive the second operation signal S42. The second drive circuit 72 generates the second drive signal B according to the second operation signal S42. Therefore, when the second operation signal S42 equivalent to the second control signal S32 is received, the second drive circuit 72 correspondingly outputs the second drive signal B to the second switch group. The second switch group correspondingly changes between a turn-on state and a turn-off state according to the time sequence change in the second drive signal B; and when the second operation signal S42 being the second control signal S32 is not received (the second operation signal S42 is at a low potential), the second drive circuit 72 stops outputting the second drive signal B (kept at the low potential). The switches Q1 and Q4 are turned off.

In some embodiments, the rectification-control circuit 5 is a digital controller, namely has the functions of digital signal processing, operation, control and the like, such as but not limited to a microcontroller, a digital signal processor (DSP), a field-programmable gate array (FPGA) or an application-specific integrated circuit (ASIC).

In some embodiments, the switches Q1-Q4 are realized by an N-type metal-oxide-semiconductor FET (NMOSFET), but the present disclosure is not limited to this. Gates of the switches Q2 and Q3 receive the first drive signal A, and the gates of the switches Q1 and Q4 receive the second drive signal B.

According to the power supply device of some embodiments of the present disclosure, the switches Q1-Q4 of the active-rectifier circuit 2 can be turned off immediately when the surge occurs. The effect of protecting the switches Q1-Q4 is achieved, and the active-rectifier circuit 2 resumes running immediately after the surge disappears.

What is claimed is:

1. A power supply device, comprising:
an input port configured to receive a power supply signal;
an active-rectifier circuit coupled to the input port;
a surge-discharge circuit coupled between the input port and the active-rectifier circuit;
a detection circuit comprising a detection end and an output end, wherein the detection end is coupled to the surge-discharge circuit, the output end outputs an output signal, normally a regular signal, and in response to detecting a surge signal from the surge-discharge circuit at the detection end, the output signal is changed from the regular signal to an activation signal;
a rectification-control circuit configured to output a control signal;
a protection-control circuit coupled to the output end of the detection circuit and the rectification-control circuit to receive the output signal and the control signal and output an operation signal, wherein in response to the output signal being the regular signal, the protection-control circuit outputs the control signal as the operation signal, and in response to the output signal being the activation signal, the protection-control circuit temporarily interrupts outputting the control signal as the operation signal; and
a drive circuit coupled between the protection-control circuit and the active-rectifier circuit to output a drive signal to the active-rectifier circuit according to the operation signal when the operation signal being the control signal is received, and stop outputting the drive signal when the operation signal being the control signal is not received.

2. The power supply device according to claim 1, wherein the detection circuit comprises a current sensing circuit positioned at the detection end to convert the surge signal into a sensing voltage.

3. The power supply device according to claim 2, wherein the detection circuit further comprises a proportional rectifier circuit coupled to the current sensing circuit to reduce the sensing voltage by a down-regulation ratio and rectify the sensing voltage into the activation signal.

4. The power supply device according to claim 3, wherein the proportional rectifier circuit comprises a transformer and two diodes; the transformer comprises a primary coil and a secondary coil; the primary coil is coupled to the current sensing circuit to receive the sensing voltage; two ends of the secondary coil are correspondingly coupled to anodes of the diodes, and cathodes of the diodes are coupled to each other and are coupled to the output end; and the down-regulation ratio corresponds to the turn ratio of the transformer.

5. The power supply device according to claim 1, wherein the protection-control circuit comprises a NOT gate and an AND gate; the NOT gate is coupled to the output end of the detection circuit to convert the regular signal into a high-potential signal when the regular signal is received, and convert the activation signal into a low-potential signal when the activation signal is received; and the AND gate, in response to receiving the high-potential signal, outputs the control signal as the operation signal, and in response to receiving the low-potential signal, temporarily interrupts outputting the control signal as the operation signal.

6. The power supply device according to claim 5, wherein the active-rectifier circuit comprises a first switch group and a second switch group; the drive signal comprises a first drive signal and a second drive signal; when the operation signal being the control signal is received, the drive circuit outputs the first drive signal to the first switch group, and outputs the second drive signal to the second switch group; and when the operation signal being the control signal is not received, the drive circuit stops outputting the first drive signal and the second drive signal.

7. The power supply device according to claim 1, wherein the protection-control circuit comprises a NOT gate, a first AND gate and a second AND gate; the control signal comprises a first control signal and a second control signal complementary with the first control signal; the NOT gate is coupled to the output end of the detection circuit to convert the regular signal into a high-potential signal when the regular signal is received, and convert the activation signal into a low-potential signal when the activation signal is received; the first AND gate, in response to receiving the high-potential signal, outputs the first control signal as a first operation signal, and in response to receiving the low-potential signal, temporarily interrupts outputting the first control signal as the first operation signal; the second AND gate, in response to receiving the high-potential signal, outputs the second control signal as a second operation signal, and in response to receiving the low-potential signal, temporarily interrupts outputting the second control signal as the second operation signal; and the first operation signal and the second operation signal form the operation signal.

8. The power supply device according to claim 7, wherein the active-rectifier circuit comprises a first switch group and a second switch group; the drive circuit comprises a first drive circuit and a second drive circuit; the drive signal comprises a first drive signal and a second drive signal; when the first operation signal being the first control signal is received, the first drive circuit outputs the first drive signal to the first switch group; when the first operation signal being the first control signal is not received, the first drive circuit stops outputting the first drive signal; when the second operation signal being the second control signal is received, the second drive circuit outputs the second drive signal to the second switch group; and when the second operation signal being the second control signal is not received, the second drive circuit stops outputting the second drive signal.
